(19) United States
(12) Patent Application Publication
(10) Pub. No.: US 2002/0000930 A1
(43) Pub. Date: Jan. 3, 2002

(54) Location detection system

(75) Inventors: R. Michael Crowson, Clyde Hill, WA (US); William E. Clise, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Locate Networks, Inc.

(21) Appl. No.: 09/825,579

(22) Filed: Apr. 2, 2001

Related U.S. Application Data
(63) Continuation-in-part of application No. 09/535,932, filed on Mar. 24, 2000.

(51) Int. Cl. G01S 5/14

(52) U.S. Cl. 342/357.1

(57) ABSTRACT

To increase the accuracy by which the location of an object can be determined, the present invention combines the accuracy of a GPS receiver (54) with a two-way paging system (68). A two-way pager (56) receives information indicative of the position of a GPS receiver (54) and transmits the information on a reverse channel to a paging service (68). The information is forwarded to a location determination service (64) that, if possible, converts the information into a location of the object and is provided to a requestor. In one embodiment of the invention, the requestor is a cellular call processor (18) and the object is a cellular telephone (50). The location information is used by the cellular call processor (62) to direct an emergency call to the appropriate emergency agency (80, 82) as well as to provide emergency personnel with a map showing the location of the caller.

### CROSS-REFERENCE TO RELATED APPLICATION

This application is a continuation-in-part of U.S. patent application Ser. No. 09/535,932, filed Mar. 24, 2000.

### FIELD OF THE INVENTION

The present invention relates to communication systems in general, and in particular, to systems for locating mobile objects or people.

### BACKGROUND OF THE INVENTION

In response to a Federal Communications Commission (FCC) mandate, cellular phone providing services will be required to implement technologies which allow the location of a cellular phone user to be determined when the user dials an emergency number such as 911. This location information will be given to emergency call centers, which can then speak with the user directly, and if necessary, dispatch people to the user's location in order to render assistance.

At the present time, the location information that can be provided to a cellular service provider is limited to a location and maybe a map of the geographic area of the particular cellular tower that is handling the cellular call. Because the geographic area serviced by such a cellular tower can be quite large, emergency personnel are often limited in their ability to accurately locate the caller in the event that they cannot speak with them directly. Also, cellular systems do not guarantee the delivery of an emergency call if a user initiates the call outside of their home coverage area.

Given this problem, there is a need for a more accurate location determining system that can provide emergency service personnel or others with an accurate indication of a caller's position.

### SUMMARY OF THE INVENTION

The present invention is a position sensing system that incorporates global positioning satellites (GPS) and a two-way paging system. Upon local activation by a user or remote activation by a paging service, a two-way paging device interacts with a GPS receiver to transmit position or location information for the user. This information is transmitted by the two-way pager to a location determination service and, in some embodiments, a location server, which provide the location of the position sensing system to a requestor who accesses the location determination service via a computer or telephone or other two-way communication device.

In one embodiment of the invention, the position sensing system, including GPS receiver and two-way pager, is associated with a cellular telephone. The location determination service provides the location of the cellular telephone to a cellular call processor when a user of the cellular telephone makes an emergency call. The cellular call processor uses the location information to select a specific emergency agency to handle the emergency call. In addition, the location determination service can use the location information to request a map showing the location of the cellular telephone from a GIS layer and data service to be forwarded to the selected emergency agency indicating the precise location of the caller.

In accordance with another aspect of the present invention, the position sensing system, including GPS receiver and two-way pager, is incorporated into a cellular phone battery pack. The location of the battery pack can be provided to a requestor without interfering with a cellular phone call made by a user. The battery pack may include a “panic” button that can be activated by a user to cause the two-way pager to interact with the GPS receiver and transmit its position or location information independent of a cellular phone call.

In accordance with yet another embodiment of the invention, the position sensing system, including two-way pager and GPS receiver, can be placed on any object (automobile, shipping container, etc.) or carried by people in order to determine a location of the object or person. The location determination service can be accessed via a telephone or via a computer or other two-way communication device to determine the location of a specific position sensing system.

In accordance with yet another aspect of the present invention, a position sensing system including a GPS receiver and a two-way wireless device can use the location of an object whose position is known as a surrogate for the location of the position sensing system if the position sensing system cannot receive GPS signals. In one embodiment, the location of a paging transceiver is used as a surrogate for the location of the position sensing system, if the position sensing system cannot receive GPS signals. In another embodiment, an object may comprise a Bluetooth™ transceiver whose position is known. The location of a particular transceiver is used as a surrogate for the location of the position sensing system when the GPS receiver cannot receive signals from the GPS satellites.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates a conventional position sensing system for cellular telephone users;

FIG. 2 illustrates a position sensing system of the present invention that is integrated with a cellular telephone system;

FIG. 3 illustrates a position sensing system, including an integrated GPS receiver, two-way pager, and battery pack, in accordance with another aspect of the present invention; and

FIG. 4 illustrates a position sensing system according to another embodiment of the present invention that operates as an independent system.

### DETAILED DESCRIPTION OF THE PREFERRED EMBODIMENT

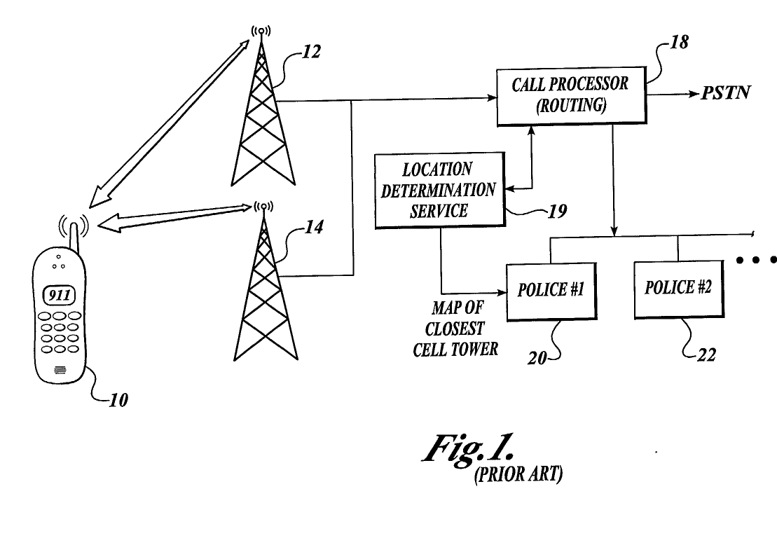

FIG. 1 illustrates a conventional method of determining the approximate position of a cellular caller during an emergency or 911 call. When a user of a cellular telephone 10 makes a telephone call, the radio frequency (RF) signals are transmitted to and received by one or more cellular towers 12, 14. A cellular call processor or router 18 determines which cellular tower 12, 14 should handle the call based on strength of the RF signals received from the cellular telephone 10. Should the position of the cellular telephone 10 change such that the received signal strength fades at one cellular tower and becomes stronger at another, the call processor 18 directs the cellular tower to hand off the call to the cellular tower with the strongest-received signal.

When a user makes a 911 call, the call processor 18 briefly determines which cellular tower 14 is handling the call and, based on an identifier for that tower, requests position information from a location determination service 19. The information provided by the location determination service 19 does not indicate the location of the caller, but instead provides the geographic location of the cellular tower handling the call. Based on the location of the tower that is handling the call, the cellular call processor 18 determines which of a number of emergency agencies 20, 22 should receive the emergency call. The call processor then routes the call to the agency having the closest proximity to the cellular tower that is handling the cellular telephone call. In addition, a map showing the vicinity of the cellular tower may be routed from the location service 19 to the selected emergency agency.

Because the cellular towers 12, 14 may have a relatively large geographic area in which they service calls, the particular emergency agency 20, 22 to which the call is routed does not have any more specific information concerning the position of the caller other than the location of the cellular tower handling the call. If the emergency agency is not able to speak to the cellular caller (if, for example, they are incapacitated), the emergency agency has little information that can be used to direct field personnel to the caller.

To improve the accuracy by which a cellular telephone can be located, the present invention incorporates the accuracy obtained with a global positioning system (GPS) and the communication ability of a two-way paging system.

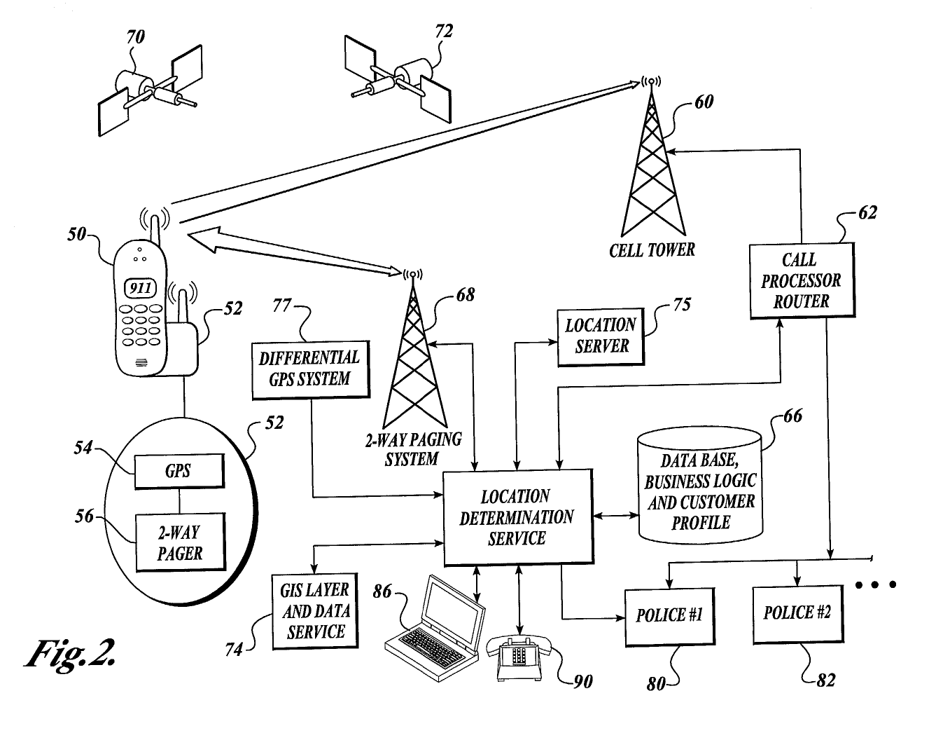

As shown in FIG. 2, a cellular telephone 50, in accordance with one aspect of the present invention, has a position sensing system 52 associated with it. The position sensing system 52 includes a GPS receiver 54 and a two-way pager 56. When a user makes an emergency call, such as a 911 call, RF signals from the cellular telephone 50 are received by a cellular tower 60 and forwarded to a cellular call processor or router 62. Before forwarding the call to an appropriate emergency agency 80, 82, the call processor 62 interacts with a location determination service 64 in accordance with the present invention. The location determination service 64 receives an identifier (typically, its assigned phone number or other identifying code) of the cellular telephone 50 making the call from the cellular call processor 62. Based on the identifier of the calling cellular telephone 50, the location determination service 64 accesses a database 66 that determines if the cellular phone is equipped with a position sensing system 52. If the cellular telephone 50 does not have a position sensing system 52, the location determination service 64 instructs the cellular call processor 62 to handle the call in the conventional fashion by determining the geographic location of the cellular tower 60 handling the call and routing the call to the emergency agency 80, 82 having jurisdiction of the area of the handling cellular tower 60.

If the cellular telephone 50 is equipped with a position sensing system 52, the location determination service 64 sends a message to a two-way paging service 68 that initiates a page to the two-way pager 56. The page is received by the two-way pager 56, and the two-way pager 56 interacts with the GPS receiver 54 to receive position information from one or more overhead GPS satellites 70, 72. In the presently preferred embodiment of the invention, the two-way paging system 68 and two-way pagers 56 are Reflex™ based systems produced by Glenayre Electronics, Inc., under license from Motorola. However, other two-way paging systems, such as Ardis or Mobitex, could be used.

The GPS receiver 54 is preferably based on a network aided, differential GPS system made by Snap Track of San Jose, Calif., and described in U.S. Pat. Nos. 6,016,119; 6,002,363; 5,999,124; 5,945,944; 5,884,214; 5,874,914; 5,841,396; 5,831,574; 5,825,327; 5,812,087; and 5,781,156, which are herein incorporated by reference. These GPS receivers have the ability to quickly determine position information in adverse conditions, such as in buildings, etc., by preloading GPS acquisition information for the position signals being transmitted from the overhead satellites, as will be described in further detail below. However, other GPS receivers could be used if desired.

Depending on the processing power available at the position sensing system 52, the GPS receiver 54 may calculate its actual location (i.e., latitude/longitude) from the GPS pseudo-range position information received from the GPS satellites and provide the calculated latitude/longitude to the two-way pager 56. Alternatively, the GPS receiver may simply provide the pseudo-range position information to the two-way pager 56 to transmit. For the purposes of the present specification the terms position and location are used interchangeably as context requires, but the terms “position information” is generally meant to refer to the raw pseudo-range information received from the GPS satellite 70, 72, and “location information” generally refers to an actual location (i.e., a latitude and longitude) that is calculated from the position information.

Once the GPS receiver 54 has received the pseudo-range position information from the GPS satellites 70, 72, the position or location information is provided to the two-way pager 56, which forwards the position or location information back to the two-way paging system 68 on a reverse paging channel. The paging system 68 returns the position or location information to the location determination service 64. If location information is received, the location determination service 64 can provide the latitude and longitude received to the cellular call processor 62. Alternatively, the location determination service 64 can access the database 66 that includes data to convert the latitude and longitude received to a routing code, which is provided to the cellular call processor 62 for routing the call to the appropriate emergency agency 80, 82. The database 66 also stores user profile data and rules for handling the location information received as will be described in further detail below.

If desired, the location determination service 64 may request a map illustrating the precise location of the user from a GIS layer and data service 74, such as that provided by ETAK of Sunnyvale, Calif. The GIS layer and data service is coupled to the location determination service 64 via a communication link, such as the Internet. The GIS layer and data service 74 generate a map and/or street address from a given set of latitude and longitude coordinates. The location determination service 64 may forward the map and/or street address showing the location of the caller to the selected emergency agency 80, 82.

If the information received from the two-way pager 56 is the pseudo-range information, the location determination system 64 may forward the received position information to a location server 75 that is programmed to produce a precise latitude and longitude from the received pseudo-range information. The calculated latitude and longitude are returned to the location determination service 64 and processing proceeds as described above. If desired, the location determination service 64 may correct the pseudo-range information based on data received from a differential GPS system 77, as will be described in further detail below.

As will be appreciated, the position sensing system 52 allows the location of a cellular caller to be determined with a far greater accuracy than was available in the prior art. In addition, the present invention can utilize the store and forward capability of the two-way paging system to ensure that a request for the two-way pager 56 to transmit its position or location information is not missed if a user is out of range. Paging systems will typically rebroadcast a page over a predetermined period, such as three days, etc., until a pager has received it. Therefore, a user who was out of range and then comes back in range will receive the page requesting their location.

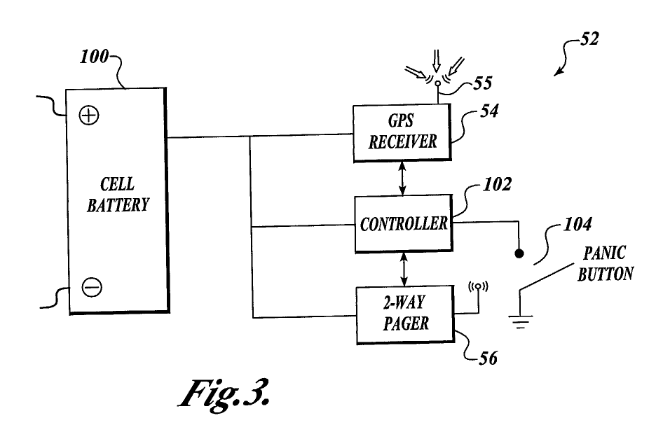

FIG. 3 illustrates in further detail the position sensing system 52 and illustrates one way in which the position sensing system 52 may be integrated with a cellular telephone. In this embodiment of the invention, the position sensing system 52 comprises an integrated cellular telephone battery pack, including a cellular telephone battery 100, the GPS receiver 54, and the two-way pager 56. Controlling electronics 102, which are preferably a programmed digital signal processor (DSP), interact with the GPS receiver 54 and the two-way pager 56 to coordinate the transfer of the position or location information produced by the GPS receiver to the two-way pager 56 and to initiate the transmission of the position or location information on the reverse paging channel in response to an external paging message that is sent to the two-way paging unit 56. The GPS receiver 54 has its own GPS antenna 55 and the two-way pager 56 has its own antenna 57. However, both the GPS receiver 54 and the two-way pager 56 could share a common antenna.

In addition, the position sensing system 52 includes a “panic” button 104 that causes the controlling electronics 102 to initiate the transmission of the position or location information without receiving a requesting page. The panic button 104 is useful for a user who cannot make a 911 cellular or landline call and wishes to alert the location determination service 64 of their present location. Such information may cause emergency personnel to be rushed to their location or may simply be used to update a database with the user's current location. Such a database can be accessed by others via a computer or telephone in order to keep track of a particular person.

As will be appreciated, the present invention is not limited to use with cellular telephones. Position sensing systems 52 of the type described above can be placed on virtually any item or carried by people to determine their current position and to transmit the position information back to a central service. Such devices can be placed on cars, delivery vehicles, shipping containers, packages, or any other object whose position is to be determined. In addition, such devices can be placed with elderly or other persons suffering from memory lapses or diseases who may become lost or disoriented.

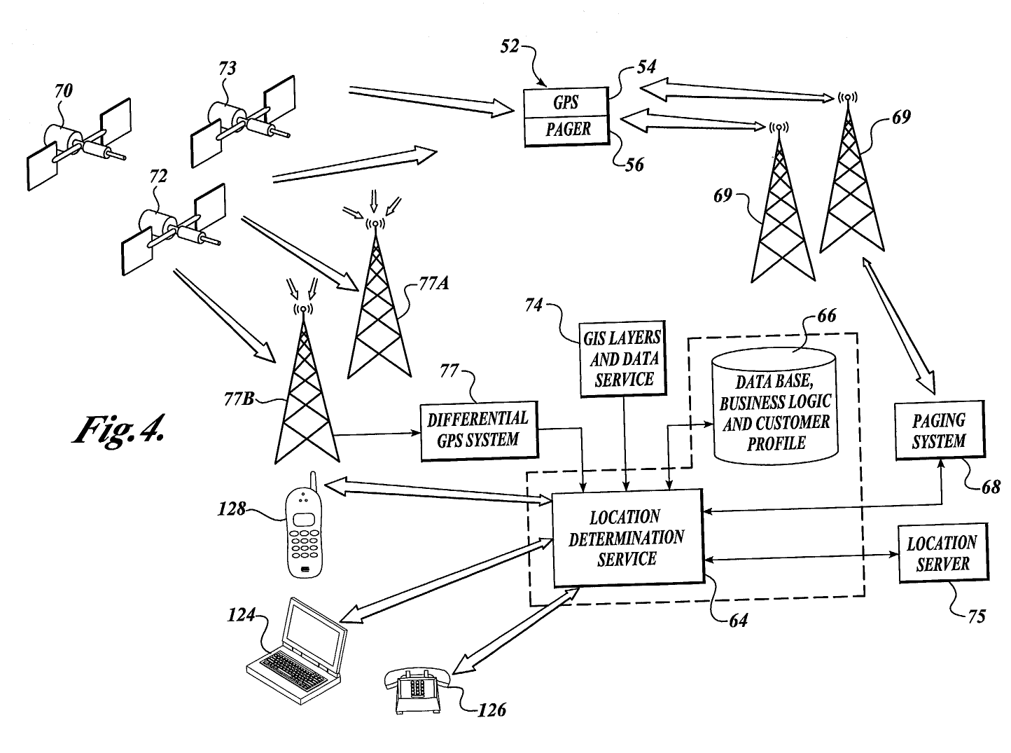

FIG. 4 illustrates an embodiment of the invention that is not connected to a cellular phone system. A requester can access the location determination service 64 to determine the location of a position sensing device 52 via a computer system 124 that is coupled to the location determination service via a computer communication link. Alternatively, a requestor can access the location detection service 64 via a telephone 126 and speak to an operator or voice recognition unit in order to determine the location of a position-sensing device 52. Alternatively, a requester can access the location detection service 64 via a radio communication link using a wireless personal digital assistant 128, such as the Palm VII® brand connected organizer, or a two-way pager. To determine the location of the position sensing device 52, the location determination service 64 interacts with the two-way paging system 68 to transmit a page to the two-way pager 56 that is included within the position sensing system 52. The two-way pager 56 interacts with the GPS receiver 54 that receives position information from the GPS satellites 70, 72, 73. The position or location information is transmitted on the reverse paging channel back to the two-way system 68. The two-way system 68 forwards the received position or location information back to the location determination service.

As discussed above, to improve the accuracy of the location information provided to a requester, the location determination system 64 interacts with a differential GPS system 77. The differential GPS system 77 receives position information from one or more GPS towers 77A, 77B, whose position is precisely known by survey. The position information received from each of the GPS towers 77A, 77B is compared with the actual known position of these towers. The differential GPS system 77 therefore calculates error corrections which are used to adjust the actual location of a position sensing system 52 located in the vicinity of a GPS tower 77A or 77B. Typically, the correction factors calculated for the GPS towers 77A, 77B are valid for relatively large geographic area surrounding the tower. For example, the same correction can be used within 300 miles surrounding each of the GPS towers 77A, 77B.

As with the examples described above, depending upon the processing power at the position sensing system 52, the location of the position sensing system 52 may be determined by the GPS receiver 54. Alternatively, the location detection service 64 may receive the position information from the two-way paging system 68 and provide the position information to the location server 75, which calculates the location including the correction determined by the differential GPS system 77. If a map is required showing the location of the position sensing system 52, the location data can be provided to a GIS layer and data service 74, which produces a map showing the location of the position sensing system 52.

As indicated above, the database 66 stores profile information for each user of the location detection service. For example, a carrier of a position sensing system 52 may wish to activate a button on the two-way pager 56 that causes his or her current location to be stored in the database and accessed by a few key individuals. What to do with the location information and the identity of the users and their passwords as to who can access the information are therefore stored in the database 66. Alternatively, if the user presses another button on the two-way pager 56, the location database 66 stores a rule that causes the location determination service 64 to contact an emergency agency and have emergency personnel dispatched to the user's location. In addition, the database 66 may store a physical description of the carrier of the position-sensing device 52 so that this information can be given to emergency personnel if desired.

As indicated above, the position sensing system 52 has an improved ability to detect GPS signals quickly and in relatively difficult locations, such as in buildings, by storing a set of access frequencies on which the GPS signals are likely to be received. This is accomplished by analyzing the GPS signals that are received by a particular GPS tower 77A, 77B. Based on the proximity of the position sensing system 52 to one of these GPS towers, the information required by the GPS receiver 54 to narrow the search for the GPS signals is periodically forwarded to the GPS receiver using the paging system 68.

While the preferred embodiment of the invention has been illustrated and described, it will be appreciated that various changes can be made therein without departing from the spirit of the invention. For example, the panic button 104 could be configured to trigger in response to a signal from a sensor placed on or in a person's body. For example, a pacemaker could send a radio frequency signal when its battery is getting low that would be received by the panic button 104 in order to trigger an emergency call. Similarly, sensors that monitor blood sugar or other functions could be used.

In some instances, the GPS receiver may not be able to receive signals from the GPS satellites. In that case, a paging transceiver can act as a surrogate to determine the location of the position sensing system 52. The paging service 68 knows which paging transceiver is communicating with the two-way pager 56 of the position sensing system 52. Because the location of the paging transceiver is known, that location can be used as a surrogate for the location of the position sensing system (although with less accuracy than the location determined from the GPS signals). The surrogate location information may be stored in a database with a flag or other indicator that indicates the fact that the location is based on the location of the paging transceiver. The location can be updated if a more accurate determination is made based on the GPS signals. Alternatively, when the user's two-way pager begins communicating with another paging transceiver, the location of the new paging transceiver is adopted as the location of the position sensing system and the new location is updated in the database.

In yet another alternative embodiment of the invention, the surrogate location information can be based on other devices whose position is known. For example, wireless devices that operate according to the Bluetooth™ protocol are being developed. These devices have the ability to communicate with other Bluetooth-compatible devices over relative short distances. The specifications for the Bluetooth protocol can be found at the Web site www.bluetooth.com. The position sensing systems 52 can be equipped to interact with Bluetooth™ transceivers whose position is known. A Bluetooth™ transceiver provides the position sensing system with an identifier that can be used to determine the location of the transceiver. The position sensing system forwards the identifier to the location determination service to determine the location of the transceiver and to use the location as a surrogate for the location of the position sensing system. Alternatively, the Bluetooth™ transceiver may provide the position sensing system with its actual location instead of an identifier from which the location can be determined.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A system for determining the location of an object, comprising:
a global positioning satellite (GPS) receiver that produces position information based on signals received from one or more global positioning satellites;
a two-way wireless communication device that receives information indicative of the location of the GPS receiver from the GPS receiver and transmits the information to a wireless transceiver; wherein the GPS receiver and wireless communication device are located with the object; and
a location determination service that receives the information indicative of the location of the GPS receiver from the wireless transceiver and provides the information to a requester.

2. The system of claim 1, wherein the two-way wireless communication device is a two-way pager and the wireless transceiver is a paging transceiver in communication with a paging service.

3. The system of claim 2, wherein the information transmitted by the two-way pager is pseudo-range information received from the one or more global positioning satellites.

4. The system of claim 2, wherein the information transmitted by the two-way pager is a latitude and longitude that is calculated from the signals received from the one or more global positioning satellites.

5. The system of claim 2, wherein the location determination service can be accessed by users via a computer communication, a telephonic link, or other two-way communication device to cause the location determination service to interact with the paging service in order to transmit a page to the two-way pager, the receipt of which causes the two-way pager to transmit the information indicative of a location of the GPS receiver back to the paging service on a reverse paging channel and wherein the paging service forwards the information to the location determination service.

6. The system of claim 2, wherein the object is a cellular telephone and the requester is a cellular call processor that interacts with the location determination service to transmit a page to the two-way pager, the receipt of which causes the two-way pager to transmit the information indicative of a location of the GPS receiver to the paging service on a reverse paging channel and wherein the location determination system forwards the information indicative of a location of the GPS receiver to the cellular call processor.

7. The system of claim 6, wherein the cellular call processor interacts with the location determination service to request the information indicative of the location of the GPS receiver when a user of the cellular telephone makes an emergency telephone call.

8. The system of claim 1, further including a GIS layer and data service that receives the information indicative of the location of the GPS receiver via a computer communication link and returns a map that shows the location of the object.

9. The system of claim 1, further including a location server that receives the information indicative of the location of the GPS receiver and computes a latitude and longitude of the object from the information.

10. The system of claim 1, wherein the two-way wireless communication device receives signals from other devices having known locations and forwards an identifier or the location of another device to the location determination service to use as a surrogate for the location of the GPS receiver when the GPS receiver cannot receive signals from the one or more global positioning satellites.

11. A device for detecting and transmitting information indicative of the location of an object, comprising:
a global positioning satellite (GPS) receiver that receives signals from one or more global positioning satellites; and
a two-way wireless communication device coupled to the GPS receiver, that receives information indicative of the location of the GPS receiver from the GPS receiver and transmits the information to a location determination service that is accessed by a requester to determine the location of the object.

12. The device of claim 11, wherein the two-way wireless communication device is a two-way pager.

13. The device of claim 12, wherein the GPS receiver and two-way pager are incorporated into a cellular telephone battery pack.

14. The device of claim 1, further comprising a switch that, when activated, causes the two-way wireless communication device to transmit the information indicative of the location of the GPS receiver to the location determination service.

15. The device of claim 14, wherein the switch is manually activated.

16. The device of claim 14, further including a sensor for receiving a physiological signal from a wearer and upon detection of a predetermined physiological condition activates the switch.

17. The device of claim 11, wherein the two-way wireless communication device receives signals from other devices whose locations are known, wherein the two-way wireless communication device forwards information indicative of either the identify or the location of the other devices to the location determination service to use as a surrogate for the location of the GPS receiver if the GPS receiver cannot receive signals from the one or more global positioning satellites.

18. The device of claim 17, wherein the other device is a paging transceiver.

19. The device of claim 17, wherein the other device is a Bluetooth™ transceiver.
